(19) United States
(12) Patent Application Publication
(10) Pub. No.: US 2014/0218933 A1
(43) Pub. Date: Aug. 7, 2014

(54) DETACHABLE LAMP

(71) Applicant: EDISON OPTO CORPORATION, New Taipei City (TW)

(72) Inventors: Shih-Tien FENG, Pingtung City (TW); Hao-Yun CHANG, New Taipei City (TW); Chien-Yu SHEN, New Taipei City (TW)

(73) Assignee: EDISON OPTO CORPORATION, New Taipei City (TW)

(21) Appl. No.: 13/846,788

(22) Filed: Mar. 18, 2013

(30) Foreign Application Priority Data
Feb. 5, 2013 (TW) 102202484

(51) Int. Cl. F21V 21/00

(52) U.S. Cl. CPC F21V 21/00
USPC 362/296.01; 362/257

(57) ABSTRACT

A detachable lamp includes a lighting module, a first engaging member, and an optical device. The lighting module includes a base and a lighting unit. The base surrounds the lighting unit. The first engaging member is disposed on the base and has a first through hole. The first through hole is aligned with the periphery of the lighting unit. The first engaging member has a plurality of engaging portions circularly disposed on the first engaging member. The optical device has a second engaging member located on the optical device. The second engaging member has a second through hole and a plurality of engaging notches. The second through hole is aligned with the first through hole. The engaging notches are circularly formed on the second engaging member, and sidewalls of the engaging notches are able to insert into the engaging portions and rotate an angle.

### RELATED APPLICATIONS

This application claims priority to Taiwanese Application Serial Number 102202484, filed Feb. 5, 2013, which is herein incorporated by reference.

### BACKGROUND

1. Technical Field

The present disclosure relates to a lamp, more particularly, to a detachable lamp.

2. Description of Related Art

In design of a lamp, a conventional light source is generally used with the adjustment of the emitted light so as to satisfy the requirements of a user to the lamp in the efficiency of light output, the coverage and the effect of the emitted light.

In recent years, Light-emitting Diodes (LEDs) features the advantages such as small size, low driving voltage, fast reaction rate, shock-proof, long lifetime, being environmentally friendly (since no mercury is used), and as a result, have the potential to fully replace conventional lighting sources. With advances and improvements of technology, the luminous efficiency of the LED not only has long been beyond that of an incandescent light bulb (about 10 to 20 m/W), but also beyond that of a fluorescent tube (about 60 to 801 m/W). In addition, in that the present demand in present electronic components is compact in size and lightweight, the LEDs has gradually replaced incandescent light bulbs and been widely used in the lamps.

Furthermore, some of the lamps are equipped with optical devices to enrich the optical change as lighting. For example, a conventionally approach is to install a reflection cover to surround a light bulb, so that the light emitted by the light bulb can be reflected by the reflection cover to a certain illumination region. In order to firmly fix the optical devices and light sources with the lamps, many different assembly parts and screws are normally required for the lamps. However, when the optical devices of the lamps need to be replaced, the many assembly parts must be removed one by one which wastes time and manpower. Moreover, a wide variety of the assembly parts also increase the production costs of the lamps.

### SUMMARY

The disclosure provides a detachable lamp for solving problems caused by the prior arts.

According to an embodiment of the disclosure, a detachable lamp includes a lighting module, a first engaging member, and an optical device. The lighting module includes a base and a lighting unit. The base surrounds the periphery of the lighting unit. The first engaging member is disposed at the top surface of the base and has a first through hole, and has a plurality of engaging portions circularly disposed at the top surface of the first engaging member. The edge of the first through hole is aligned with the periphery of the lighting unit. The optical device has a second engaging member located at the bottom surface of the optical device. The second engaging member has a second through hole and a plurality of engaging notches. The edge of the second through hole is aligned with the edge of the first through hole. The engaging notches are circularly formed on the second engaging member. After sidewalls of the engaging notches respectively insert into the engaging portions and the second engaging member rotates an angle relative to the first engaging member, such that the second engaging member is detachably engaged with the first engaging member.

In an embodiment of the disclosure, after the second engaging member is detachably engaged with the engaging portions, the top surfaces of the engaging portions are higher than the top surface of the second engaging member.

In an embodiment of the disclosure, each of the engaging portions has an extending portion and an abutting portion. The extending portion is vertically formed from the top surface of the first engaging member. The abutting portions of the engaging portions each are extended from the corresponding extending portion along the same rotational direction.

In an embodiment of the disclosure, after the second engaging member is detachably engaged with the engaging portions, the top surfaces of the abutting portions are higher than the top surface of the second engaging member.

In an embodiment of the disclosure, after the second engaging member is detachably engaged with the engaging portions, the abutting portions abut against the top surface of the second engaging member.

In an embodiment of the disclosure, the number of the engaging portions is equal to the number of the engaging notches.

In an embodiment of the disclosure, the first engaging member is annular.

In an embodiment of the disclosure, the second engaging member is annular.

In an embodiment of the disclosure, the optical device is a reflector cup.

In an embodiment of the disclosure, the first engaging member and the engaging portions are integrally formed.

According to another embodiment of the disclosure, a detachable lamp includes a lighting module, a first engaging member, and an optical device. The lighting module includes a base and a lighting unit. The base surrounds the periphery of the lighting unit and has a first engaging member. The first engaging member is disposed at the top surface of the base and has a first through hole. The edge of the first through hole is aligned with the periphery of the lighting unit. The first engaging member has a plurality of engaging portions circularly disposed at the top surface of the first engaging member. The optical device has a second engaging member located at the bottom surface of the optical device. The second engaging member has a second through hole and a plurality of engaging notches. The edge of the second through hole is aligned with the edge of the first through hole. The engaging notches are circularly formed on the second engaging member. After sidewalls of the engaging notches respectively insert into the engaging portions and the second engaging member rotates an angle relative to the first engaging member, the second engaging member is detachably engaged with the first engaging member.

In an embodiment of the disclosure, after the second engaging member is detachably engaged with the engaging portions, the top surfaces of the engaging portions are higher than the top surface of the second engaging member.

In an embodiment of the disclosure, each of the engaging portions has an extending portion and an abutting portion. The extending portion is vertically formed from the top surface of the first engaging member. The abutting portions of the engaging portions each are extended from the corresponding extending portion along the same rotational direction.

In an embodiment of the disclosure, after the second engaging member is detachably engaged with the engaging portions, the top surfaces of the abutting portions are higher than the top surface of the second engaging member.

In an embodiment of the disclosure, after the second engaging member is detachably engaged with the engaging portions, the abutting portions abut against the top surface of the second engaging member.

In an embodiment of the disclosure, the number of the engaging portions is equal to the number of the engaging notches.

In an embodiment of the disclosure, the first engaging member is annular.

In an embodiment of the disclosure, the second engaging member is annular.

In an embodiment of the disclosure, the optical device is a reflector cup.

In an embodiment of the disclosure, the first engaging member and the engaging portions are integrally formed.

According to the foregoing embodiments, it can be seen that the detachable lamp of the disclosure is able to assemble or disassemble the optical device relative to the lighting module by rotating the first engaging member relative to the second engaging member. That is, only the first engaging member and the second engaging member are the components in the detachable lamp that are involved in assembly or disassembly of the optical device relative to the lighting module, so the detachable lamp has fewer components and thus is less weight. Moreover, by rotating the first engaging member relative to the second engaging member to assemble or disassemble the optical device relative to the lighting module, the optical device can be rapidly equipped with other types of optical devices, so the detachable lamp can generate different optical effects from the various kinds of the equipped optical devices.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 is a perspective view of a detachable lamp according to an embodiment of the disclosure;

FIG. 2 is a perspective view of the detachable lamp in FIG. 1, in which the detachable lamp is disassembled;

FIG. 3 is a perspective view of a detachable lamp according to another embodiment of the disclosure, in which the detachable lamp is disassembled;

FIG. 4 is a top view of the optical device of the detachable lamp in FIG. 1, in which the first engaging member is placed on the optical device before engaged with the optical device;

FIG. 5 is a partial and enlarged side view of portion A in FIG. 4;

FIG. 6 is a top view of the optical device of the detachable lamp in FIG. 1, in which the first engaging member is placed on the optical device after engaged with the optical device;

FIG. 7 is a partial and enlarged side view of portion B in FIG. 6;

FIG. 8 is another partial and enlarged side view of the portion A in FIG. 4 according to another embodiment of the disclosure;

FIG. 9 is another partial and enlarged side view of the portion B in FIG. 6 according to another embodiment of the disclosure; and

FIG. 10 is another partial and enlarged side view of the portion B in FIG. 6 according to another embodiment of the disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

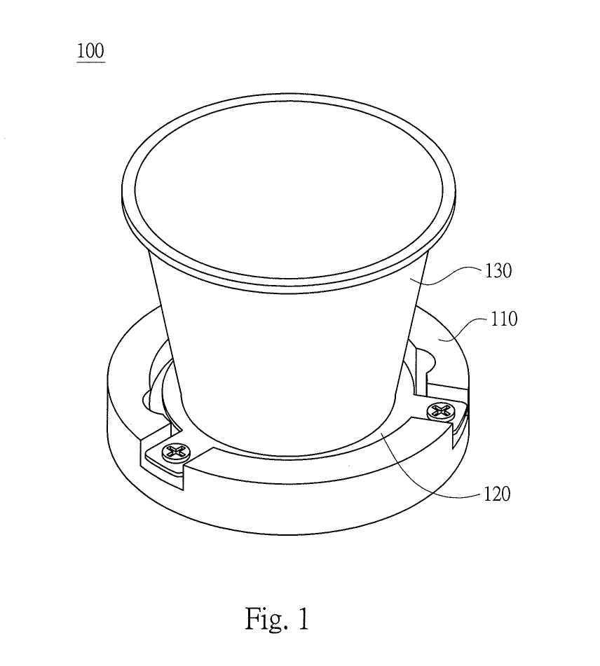

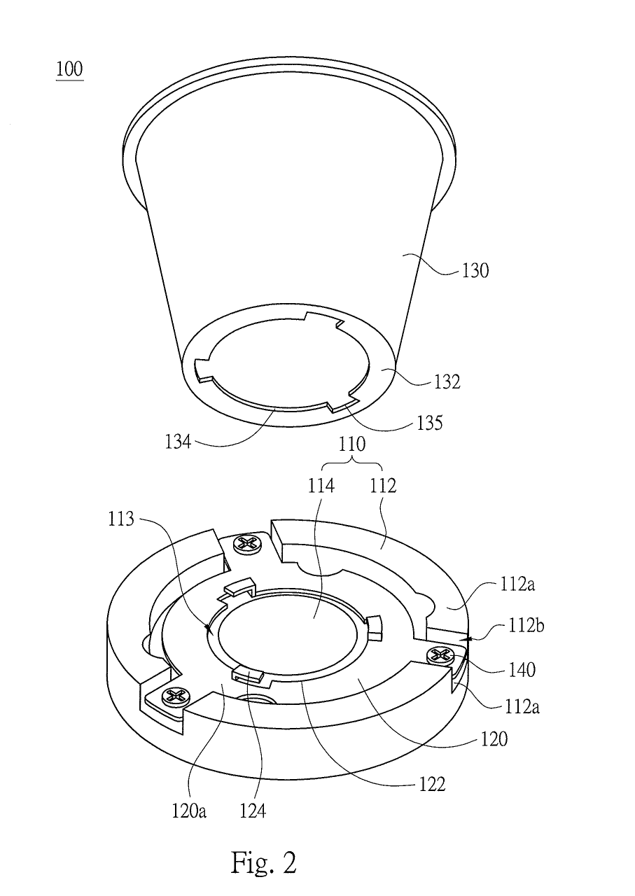

FIG. 1 is a perspective view of a detachable lamp 100 according to an embodiment of the disclosure. FIG. 2 is a perspective view of the detachable lamp 100 in FIG. 1, in which the detachable lamp is disassembled.

As shown in FIG. 1 and FIG. 2, the detachable lamp 100 includes a lighting module 110, a first engaging member 120, and an optical device 130. After electrically connecting to an external power source, the lighting module 110 emits light. The lighting module 110 can be assembled to the optical device 130 by the first engaging member 120, so as to form the detachable lamp 100. In addition, the optical device 130 is able to adjust the light emitted by the lighting module 110, so the light passing through the optical device 130 has a specific optical effect.

Furthermore, the lighting module 110 includes a base 112 and a lighting unit 114. The base 112 surrounds the periphery of the lighting unit 114. For example, a recessed opening 113 is formed between the base 112 and the lighting unit 114, and the lighting unit 114 emits light via the recessed opening 113, but the disclosure is not limited in this regard.

In the embodiment of the disclosure, the lighting unit 114 is a LED (Light-Emitting Diode), but the disclosure is not limited in this regard. In addition, the lighting unit 114 is formed by COB (Chip On Board) method, but the disclosure is not limited in this regard.

In the embodiment of the disclosure, the lighting module 110 is a surface light source lighting module. In other embodiments of the disclosure, the lighting module 110 can be a point light source lighting module or a line light source lighting module, in which the point light source lighting module is formed by a plurality of point light source lighting units. Furthermore, the lighting module 110 can also be formed by assembling at least two of a surface light source lighting unit, a point light source lighting unit, and a line light source lighting unit.

In the embodiment of the disclosure, the luminance of the lighting unit 114 can be 3000 lm, 2000 lm, 1000 lm or 800 lm, and the CRI (Color Rendering Index) of the lighting unit 114 can be higher than 80, but the disclosure is not limited in this regard. It should be noticed that the features of the lighting unit 114 and the kinds of the lighting module 110 discussed above are only illustrative, rather than limiting the disclosure.

The first engaging member 120 is disposed at the top surface 112a of the base 112 of the lighting module 110. The first engaging member 120 has a first through hole 122. The edge of the first through hole 122 is aligned with the periphery of the lighting unit 114 of the lighting module 110. That is, the light emitted by the lighting unit 114 of the lighting module 110 passes through the first through hole 122 of the first engaging member 120 without obscured. The first engaging member 120 has a plurality of engaging portions 124, and the engaging portions 124 are circularly disposed at the top surface 120a of the first engaging member 120. The engaging portions 124 horizontally surround the first through hole 122 and are disposed at the top surface 120a of the first engaging member 120. In some embodiments of the disclosure, the first engaging member 120 is annular, which means that the first engaging member 120 is formed by concentrically removing a small circular disk from a big circular disk, but the disclosure is not limited in this regard. It should be pointed out that under the circumstances that the engaging portions 124 are circularly disposed at the top surface 120a of the first engaging member 120 and the first through hole 122 of the first engaging member 120 does not obscure the light emitted by the lighting unit 114, the first engaging member 120 could be any shape. For example, the first engaging member 120 could be circular with a through hole or other shapes. In the embodiment of the disclosure, the first engaging member 120 and the engaging portions 124 are integrally formed, but the disclosure is not limited in this regard.

In some embodiments of the disclosure, the detachable lamp 100 further includes a plurality of fastening members 140. The fastening members 140 are used to fasten the first engaging member 120 to the top surface 112a of the base 112. In an embodiment of the disclosure, the fastening members 140 are screws, but the disclosure is not limited in this regard. In addition, in the embodiment of the disclosure, the fastening members are fastened in recessed portions 112b of the base 112, but the disclosure is not limited in this regard.

The optical device 130 has a second engaging member 132. The second engaging member 132 is located at the bottom surface of the optical device 130. In addition, the second engaging member 132 is formed by radially extending from the bottom surface of the optical device 130. In the embodiment of the disclosure, the second engaging member 132 radially and inwardly extends from the periphery of the bottom surface of the optical device 130. In another embodiment of the disclosure, the second engaging member 132 radially and outwardly extends from the periphery of the bottom surface of the optical device 130, but the disclosure is not limited in this regard.

The second engaging member 132 has a second through hole 134 and a plurality of engaging notches 135. When the optical device 130 is assembled to the first engaging member 120 and the first engaging member 120 is assembled to the lighting module 110, the edge of the second through hole 134 is aligned with the edge of the first through hole 122. That is, the edge of the second through hole 134 is aligned with the periphery of the lighting unit 114 of the lighting module 110. Therefore, the light emitted by the lighting unit 114 of the lighting module 110 passes through the second through hole 134 without obscured by the second engaging member 132.

The engaging notches 135 are circularly formed on the second engaging member 132, and sidewalls of the engaging notches 135 are able to insert into the engaging portions 124 of the first engaging member 120. After the sidewalls of the engaging notches 135 respectively insert into the engaging portions 124 of the first engaging member 120 and the second engaging member 132 of the optical device 130 rotate an angle relative to the second engaging member 120, the second engaging member 132 is detachably engaged with the first engaging member 120. That is, by horizontally rotating the second engaging member 132 relative to the first engaging member 120 clockwise (or counterclockwise), the second engaging member 132 is assembled to (or disassembled from) the first engaging member 120. In other words, under the circumstance that the first engaging member 120 and the second engaging member 132 of the optical device 130 is assembled, the second engaging member 132 will be disassembled from the first engaging member 120 by rotating an angle relative to the first engaging member 120. Therefore, the lighting module 110 can assemble different kinds of optical devices 130 to change different optical effects.

After the second engaging member 132 is detachably engaged with the engaging portions 124, the top surfaces of the engaging portions 124 are higher than the top surface 132a of the second engaging member 132. In the embodiment of the disclosure, both the number of the engaging portions 124 and the number of the engaging notches 135 are equal to three, but the disclosure is not limited in this regard. Both the number of the engaging portions 124 and the number of the engaging notches 135 are plural numbers that are at least larger than two. In the embodiment of the disclosure, the second engaging member 132 is annular, which means that the second engaging member 132 is formed by concentrically removing a small circular disk from a big circular disk, but the disclosure is not limited in this regard. It should be pointed out that under the circumstances that the engaging notches 135 are circularly formed on the second engaging member 132 and the second through hole 134 of the second engaging member 132 does not obscure the light emitted by the lighting unit 114, the second engaging member 132 could be any shape. For example, the second engaging member 132 could be circular with a through hole or other shapes.

In the embodiment of the disclosure, the optical device 130 is a reflector cup that is a cup-shaped structure of which the inner wall has reflecting structures. The shape of the reflector cup and the reflecting structures on the inner wall can control the optical distance and the illumination area of the emitted light. For example, the emitting angle of the reflector cup can be 25 degrees, 35 degrees, or 60 degrees, but the disclosure is not limited in this regard. In the embodiment of the disclosure, the detachable lamp 100 can be used in SLMs (Spot Light Modules), but the disclosure is not limited in this regard.

In another embodiment of the disclosure, the optical device 130 is an optical lens, and the optical lens can be a concave lens, a convex lens, or a compound lens that combines a concave lens and a convex lens. Owing to the structural characteristics of the optical lens, the light can be focused or diverged accordingly. In some embodiments of the disclosure, the optical device 130 is a lampshade, in which translucent portions of the lampshade form specific pattern. After passing through the translucent portions of the lampshade, the emitted light of the detachable lamp 100 generates a specific visual effect and is aesthetic. Furthermore, the detachable lamp 100 of the disclosure can be used in chandeliers, headlights, spotlights, etc., but the disclosure is not limited in this regard. In some embodiment of the disclosure, the lighting module 110 further includes a heat-dissipating device. The heat-dissipating device can be disposed at the bottom of the base 112. When the lighting module 110 emits light, the heat-dissipating device dissipates the heat generated by the lighting module 110.

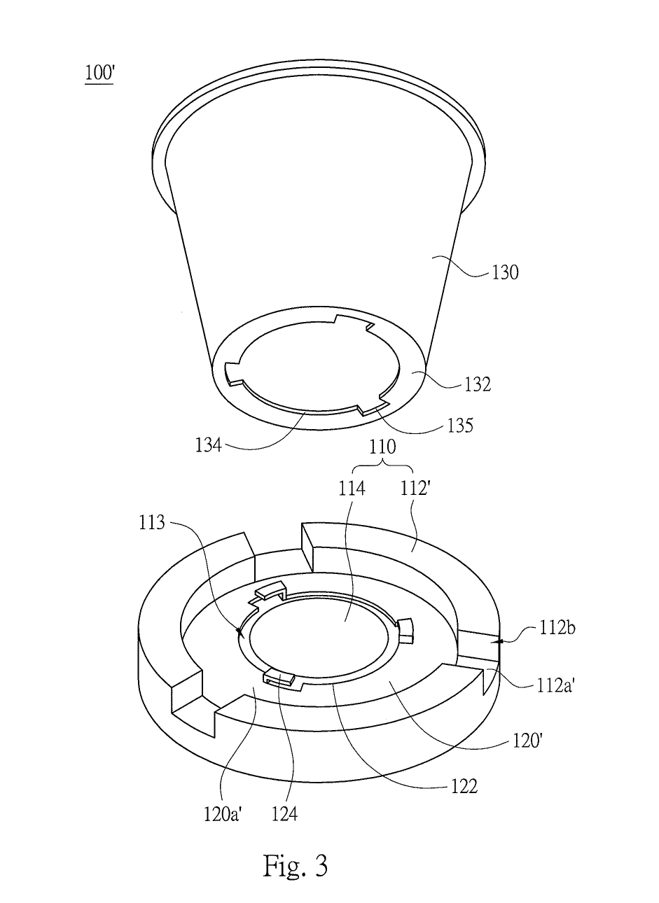

FIG. 3 is a perspective view of a detachable lamp 100′ according to another embodiment of the disclosure, in which the detachable lamp 100′ is disassembled. It should be pointed out that the difference between the detachable lamp 100′ in FIG. 3 and the detachable lamp 100 in FIG. 1 and FIG. 2 is that base 112′ and first engaging member 120′ of the detachable 100′ are integrally formed. That is, the base 112′ has the first engaging member 120′, and the first engaging member 120′ is formed at the top surface 112a′ of the base 112′. The functions and ways to use of the detachable lamp 100′ in FIG. 3 are similar to those of the detachable lamp 100 in FIG. 1 and FIG. 2.

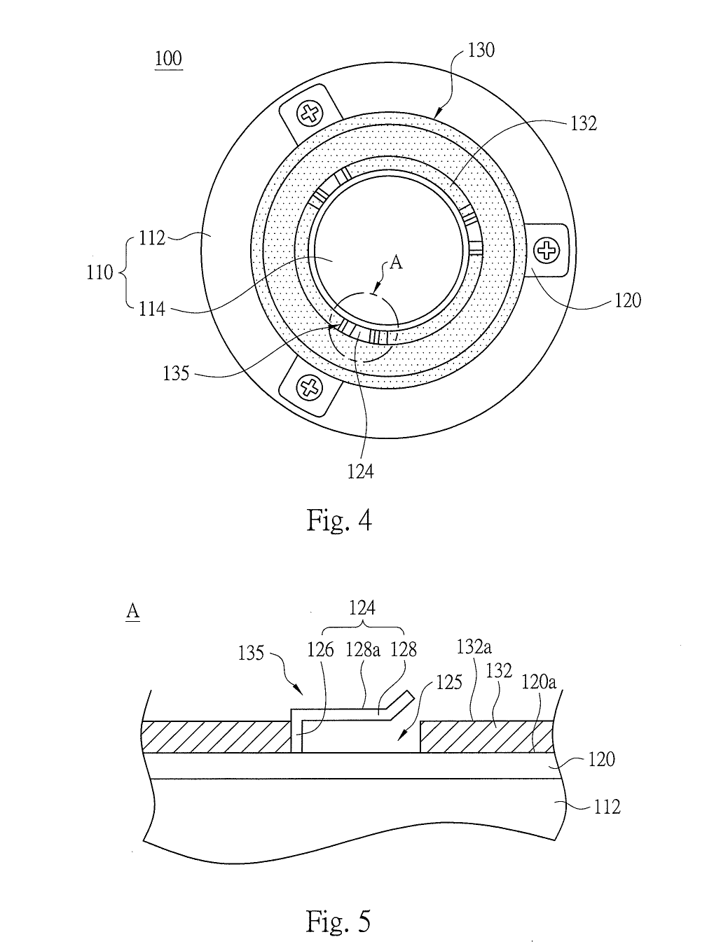

FIG. 4 is a top view of the optical device 130 of the detachable lamp 100 in FIG. 1, in which the first engaging member 120 is placed on the optical device 130 before engaged with the optical device 130. FIG. 5 is a partial and enlarged side view of portion A in FIG. 4.

As shown in FIG. 4 and FIG. 5, each of the engaging portions 124 has an extending portion 126 and an abutting portion 128. The extending portion 126 is vertically formed from the top surface 120a of the first engaging member 120. The abutting portions 128 of the engaging portions 124 each are extended from the corresponding extending portion 126 along the same rotational direction. In the embodiment of the disclosure, the end of each of the abutting portions 128 that is away from the corresponding extending portion 126 extends upward along an arc, but the disclosure is not limited in this regard. In order to connect the optical device 130 to the lighting module 110 by assembling the second engaging member 132 to the first engaging member 120, the sidewalls of the engaging notches 135 of the second engaging member 132 must insert into the engaging portions 124, respectively. Therefore, the shape of the projection of each of the engaging notches 135 on a horizontal plane is substantially equal to the shape of the projection of the abutting portion 128 of the corresponding engaging portion 124, but the disclosure is not limited in this regard. In some embodiments of the disclosure, the area of the projection of each of the engaging notches 135 on a horizontal plane is slightly larger than the area of the projection of the abutting portion 128 of the corresponding engaging portion 124, but the disclosure is not limited in this regard. In addition, the vertical distance between each of the abutting portions 128 and the top surface 120a of the first engaging member 120 is substantially smaller than the thickness of the second engaging member 132. That is, the height of each of the extending portions 126 is substantially smaller than the thickness of the second engaging member 132, but the disclosure is not limited in this regard.

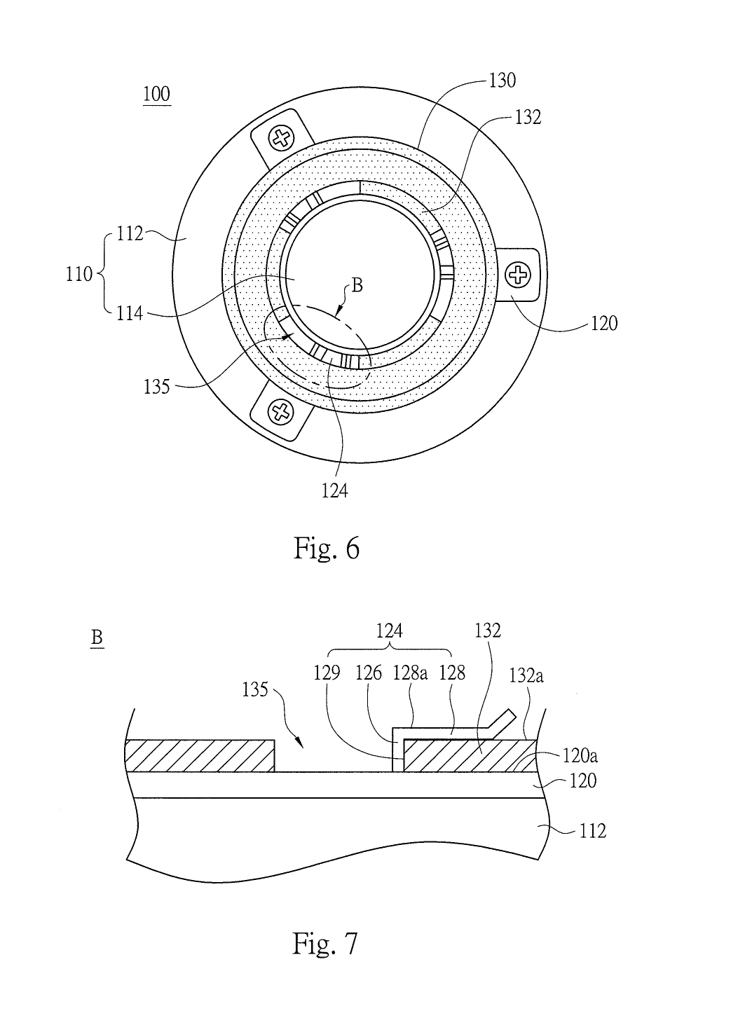

FIG. 6 is a top view of the optical device 130 of the detachable lamp 100 in FIG. 1, in which the first engaging member 120 is placed on the optical device 130 after engaged with the optical device 130. FIG. 7 is a partial and enlarged side view of portion B in FIG. 6.

As shown in FIG. 6 and FIG. 7, the end of each of the abutting portions 128 that is away from the corresponding extending portion 126 extends upward along an arc. Therefore, after the sidewalls of the engaging notches 135 of the second engaging member 132 respectively insert into the engaging portions 124, the engaging notches 135 of the second engaging member 132 can rotate an angle relative to the extending portions 126, so as to make the sidewalls of the second engaging member 132 respectively insert into spaces 125 (as shown in FIG. 5) each is formed by an extending portion 126 and the corresponding abutting portion 128 from the end of the abutting portions 128 that is away from the extending portion 126.

Because the vertical distance between each of the abutting portions 128 and the top surface 120a of the first engaging member 120 is substantially smaller than the thickness of the second engaging member 132, when the sidewalls of the second engaging member 132 respectively move into spaces 125, the abutting portions 128 abut against the top surface 132a of the second engaging member 132, so as to engage the second engaging member 132 and the first engaging member 120, but the disclosure is not limited in this regard. Under the circumstance that the second engaging member 132 and the first engaging member 120 are engaged to each other, the second engaging member 132 can be disassembled from the first engaging member 120 by rotating the second engaging member 132 an angle relative to the first engaging member 120 to make each of the engaging notches 135 leave the corresponding extending portion 126, so as to make the sidewalls of the second engaging member 132 move out of the spaces 125 (as shown in FIG. 5) each is formed by an extending portion 126 and the corresponding abutting portion 128.

In the embodiment of the disclosure, the second engaging member 132 can be assembled to the first engaging member 120 by rotating clockwise relative to the first engaging member 120, and can be disassembled from the first engaging member 120 by rotating counterclockwise relative to the first engaging member 120. In other embodiment of the disclosure, the end of each of the abutting portions 128 extends from the corresponding extending portion 126 along another rotational direction different from the rotational direction shown in FIG. 2, so the second engaging member 132 can be assembled to the first engaging member 120 by rotating counterclockwise relative to the first engaging member 120.

When a sidewall of each of the engaging notches 135 of the second engaging member 132 abuts against the inner wall 129 of the corresponding extending portion 126, the second engaging member 132 can be firmly engaged to the first engaging member 120, so as to make the optical device 130 and the lighting module 110 that connects the first engaging member 120 to form the detachable lamp 100.

In the embodiment of the disclosure, the engaging portions 124 are made of elastic metal, but the disclosure is not limited in this regard. In another embodiment of the disclosure, the engaging portions 124 are thermoplastic elastomers (e.g., made of elastic plastic). When the second engaging member 132 is engaged with the engaging portions 124, the elasticity of the abutting portions 128 of the engaging portions 124 can further enforce the stability of the fixed intensity between each of the engaging portions 124 and the second engaging member 132. In addition, when the second engaging member 132 is engaged with the engaging portions 124, the abutting portions 128 of the engaging portions 124 abut against the top surface 132a of the second engaging member 132. That is, the top surface 128a of each of the abutting portions 128 is higher that the top surface 132a of the second engaging member 132.

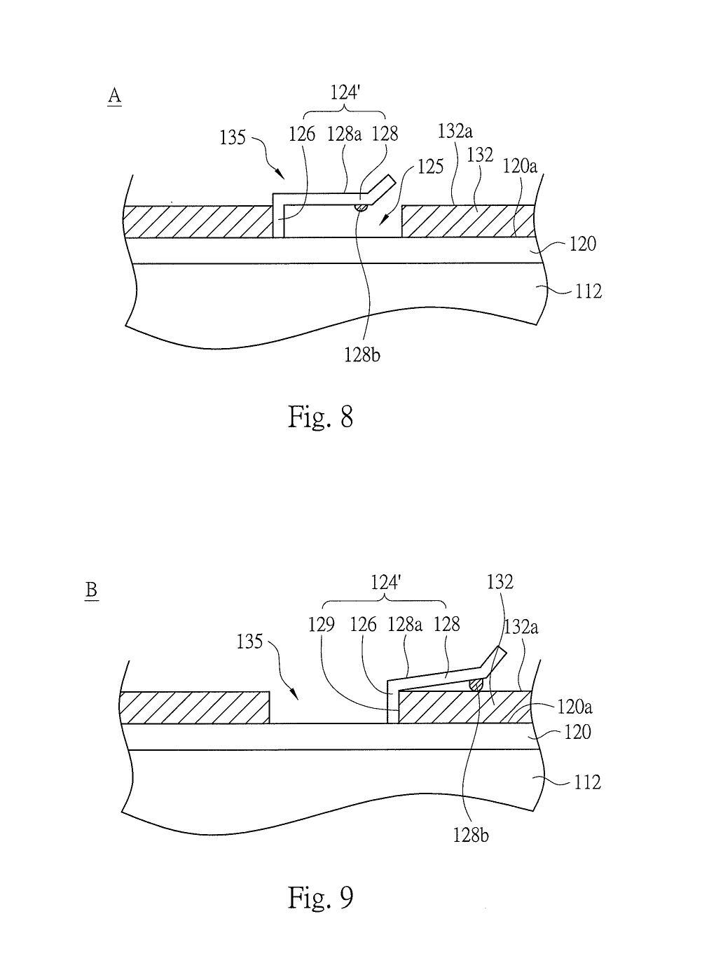

FIG. 8 is another partial and enlarged side view of the portion A in FIG. 4 according to another embodiment of the disclosure. FIG. 9 is another partial and enlarged side view of the portion B in FIG. 6 according to another embodiment of the disclosure.

As shown in FIG. 8 and FIG. 9, each of the abutting portions 128 has a protrusion 128b for abutting against the second engaging member 132, in which each of the protrusions 128 is disposed on the surface of the corresponding abutting portion 128 that is adjacent to the second engaging member 132. When the sidewalls of the second engaging member 132 slide into the engaging portions 124′, the protrusions 128b abut against the second engaging member 132, so that the second engaging member 132 is engaged with the first engaging member 120 by the protrusions 128b.

In some embodiments of the disclosure, the protrusions 128b are spherical protrusions, but the disclosure is not limited in this regard. In other embodiments of the disclosure, the protrusions 128b have elastic components, so as to enhance the stability of fixing between the second engaging member 132 and the engaging portions 124′ after assembled.

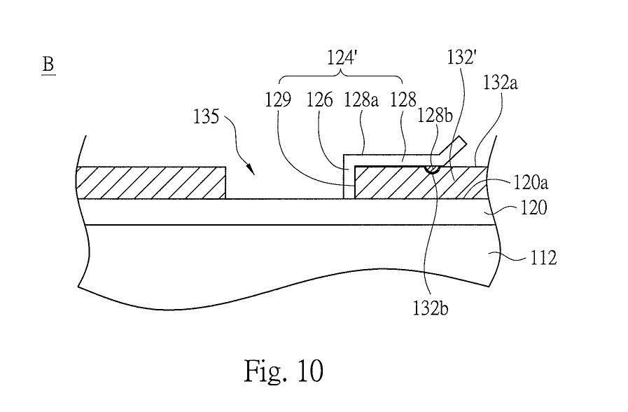

FIG. 10 is another partial and enlarged side view of the portion B in FIG. 6 according to another embodiment of the disclosure.

As shown in FIG. 10, the second engaging member 132′ further has a plurality of grooves 132b, in which the grooves 132b are formed at the top surface 132a of the second engaging member 132′ and are located at positions against which the protrusions 128b abut. When the sidewalls of the second engaging member 132′ slide into the engaging portions 124′, each of the protrusions 128b can slide into the corresponding groove 132b, so as to enhance the stability of fixing between the second engaging member 132′ and the engaging portions 124′ after assembled. In the embodiment of the disclosure, the protrusions 128b are spherical protrusions and the grooves 132b are spherical grooves, but the disclosure is not limited in this regard. Therefore, when the second engaging member 132′ slide out of the engaging portions 124′, the protrusions 128b slide out of the grooves 132b and thus make the second engaging member 132′ be disassembled from the engaging portions 124′.

According to the foregoing recitations of the embodiments of the disclosure, it can be seen that the detachable lamp of the disclosure is able to assemble or disassemble the optical device relative to the lighting module by rotating the first engaging member relative to the second engaging member. That is, only the first engaging member and the second engaging member are the components in the detachable lamp that are involved in assembly or disassembly of the optical device relative to the lighting module, so the detachable lamp has fewer components and thus is less weight. Moreover, by rotating the first engaging member relative to the second engaging member to assemble or disassemble the optical device relative to the lighting module, the optical device can be rapidly equipped with other types of optical devices, so the detachable lamp can generate different optical effects from the various kinds of the equipped optical devices.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A detachable lamp comprising:
a lighting module comprising a base and a lighting unit, the base surrounding the periphery of the lighting unit;
a first engaging member disposed at the top surface of the base and having a first through hole, the first engaging member having a plurality of engaging portions circularly disposed at the top surface of the first engaging member, wherein the edge of the first through hole is aligned with the periphery of the lighting unit; and
an optical device having a second engaging member located at the bottom surface of the optical device, the second engaging member having a second through hole and a plurality of engaging notches, wherein the edge of the second through hole is aligned with the edge of the first through hole, the engaging notches are circularly formed on the second engaging member, and after sidewalls of the engaging notches respectively insert into the engaging portions and the second engaging member rotates an angle relative to the first engaging member, such that the second engaging member is detachably engaged with the first engaging member.

2. The detachable lamp of claim 1, wherein after the second engaging member is detachably engaged with the engaging portions, the top surfaces of the engaging portions are higher than the top surface of the second engaging member.

3. The detachable lamp of claim 1, wherein each of the engaging portions has an extending portion and an abutting portion, the extending portion is vertically formed from the top surface of the first engaging member, and the abutting portions of the engaging portions each are extended from the corresponding extending portion along the same rotational direction.

4. The detachable lamp of claim 3, wherein after the second engaging member is detachably engaged with the engaging portions, the top surfaces of the abutting portions are higher than the top surface of the second engaging member.

5. The detachable lamp of claim 4, wherein after the second engaging member is detachably engaged with the engaging portions, the abutting portions abut against the top surface of the second engaging member.

6. The detachable lamp of claim 1, wherein the number of the engaging portions is equal to the number of the engaging notches.

7. The detachable lamp of claim 1, wherein the first engaging member is annular.

8. The detachable lamp of claim 1, wherein the second engaging member is annular.

9. The detachable lamp of claim 1, wherein the optical device is a reflector cup.

10. The detachable lamp of claim 1, wherein the first engaging member and the engaging portions are integrally formed.

11. A detachable lamp comprising:
a lighting module comprising a base and a lighting unit, the base surrounding the periphery of the lighting unit and having a first engaging member, the first engaging member being disposed at the top surface of the base and having a first through hole, the edge of the first through hole being aligned with the periphery of the lighting unit, wherein the first engaging member has a plurality of engaging portions circularly disposed at the top surface of the first engaging member; and
an optical device having a second engaging member located at the bottom surface of the optical device, the second engaging member having a second through hole and a plurality of engaging notches, wherein the edge of the second through hole is aligned with the edge of the first through hole, the engaging notches are circularly formed on the second engaging member, and after sidewalls of the engaging notches respectively insert into the engaging portions and the second engaging member rotates an angle relative to the first engaging member, the second engaging member is detachably engaged with the first engaging member.

12. The detachable lamp of claim 11, wherein after the second engaging member is detachably engaged with the engaging portions, the top surfaces of the engaging portions are higher than the top surface of the second engaging member.

13. The detachable lamp of claim 11, wherein each of the engaging portions has an extending portion and an abutting portion, the extending portion is vertically formed from the top surface of the first engaging member, and the abutting portions of the engaging portions each are extended from the corresponding extending portion along the same rotational direction.

14. The detachable lamp of claim 13, wherein after the second engaging member is detachably engaged with the engaging portions, the top surfaces of the abutting portions are higher than the top surface of the second engaging member.

15. The detachable lamp of claim 14, wherein after the second engaging member is detachably engaged with the engaging portions, the abutting portions abut against the top surface of the second engaging member.

16. The detachable lamp of claim 11, wherein the number of the engaging portions is equal to the number of the engaging notches.

17. The detachable lamp of claim 11, wherein the first engaging member is annular.

18. The detachable lamp of claim 11, wherein the second engaging member is annular.

19. The detachable lamp of claim 11, wherein the optical device is a reflector cup.

20. The detachable lamp of claim 11, wherein the first engaging member and the engaging portions are integrally formed.
